(19) United States
(12) Patent Application Publication
(10) Pub. No.: US 2008/0210741 A1
(43) Pub. Date: Sep. 4, 2008

(54) WELD REPAIR AS A COMBINED HEAT TREATMENT BRAZING PROCESS FOR METALLIC COMPONENTS

(75) Inventors: Christopher E. Thompson, Danvers, MA (US); Warren Martin Miglietti, Greenville, SC (US); Matthew James O'Connell, Simpsonville, SC (US)

Correspondence Address: NIXON & VANDERHYE P.C., 901 NORTH GLEBE ROAD, 11TH FLOOR, ARLINGTON, VA, 22203, US

(73) Assignee: GENERAL ELECTRIC COMPANY, Schenectady, NY (US)

(21) Appl. No.: 11/680,675

(22) Filed: Mar. 1, 2007

(51) Int. Cl. B23K 31/02

(52) U.S. Cl. 228/155; 228/175; 420/442

(57) ABSTRACT

A method for welding and brazing a metallic component, such as, for example, a metallic component in a turbine, such as a bucket or blade. The method includes the steps of welding the metallic component to create a welded component; covering the welded component with a braze material to create a braze-covered welded component; and subjecting the braze-covered welded component to stress relief treatment.

### BACKGROUND OF THE INVENTION

Turbine bucket/blade tips on advanced engine components may experience degradation as a result of thermal fatigue cracking and oxidation. Preferably, welding may be used to repair these buckets tips. The filler metal preferably is a highly oxidation resistant filler metal containing greater than 2% aluminum (Al) and 2% titanium (Ti).

When welding bucket tips, a common distress mode can be strain-age cracking. This mechanism for cracking may occur during a post-weld stress relief and/or solution heat treatment on the welded article. Stresses induced during the welding process are preferably relieved prior to an active service of a component at an elevated temperature. As a result of the magnitude of the stresses and the brittle nature of the superalloy materials, the parts may potentially relieve themselves catastrophically during the heat treatment, possibly causing an undesirable indication in the component.

### BRIEF DESCRIPTION OF THE INVENTION

In a preferred embodiment, the present invention relates to a method for welding and brazing a metallic component. The method preferably includes the steps of: welding the metallic component to create a welded component; covering the welded component with a braze material to create a braze-covered welded component; and subjecting the braze-covered welded component to stress relief treatment.

### BRIEF DESCRIPTION OF THE DRAWINGS

FIG. 1 illustrates a top view of an exemplary bucket tip in accordance with an exemplary embodiment of the present invention.

FIG. 2 illustrates a side view of an exemplary bucket tip after being weld repaired using a laser cladding process in accordance with an exemplary embodiment of the present invention.

FIG. 3 illustrates an exemplary bucket tip in the as-brazed condition in accordance with an exemplary embodiment of the present invention.

### DETAILED DESCRIPTION OF THE INVENTION

A brazing method that may repair stresses in metallic components (such as, for example, turbine bucket tips) has been developed. This method may use a thin layer of braze tape, powder, or paste, which may be applied by a variety of mechanisms to a welded bucket tip—or other turbine or metallic component—prior to heat treatment. If strain-age cracks occur on the heat-up cycle, they may be filled with the braze at the stress relief temperature, thus repairing the cracks as they are formed. A final contour-blending process may be all that remains to be completed after the parts are run through the combined stress relief brazing heat treatment.

In certain embodiments, metallic components suitable for use in connection with the currently described and claimed method include superalloys, preferably superalloys suitable for use in turbines. Suitable superalloys include, for example, nickel-based, cobalt-based, iron-based, and nickel-iron-based superalloys.

When repairing superalloy turbine buckets, many welding re-work cycles may be required, potentially as a result of strain-age cracking after post-weld stress relief heat treatment. This re-work may be difficult and time consuming. By using a combination weld and braze repair this re-work cycle may be eliminated, possibly reducing both fallout and cycle time.

Many braze repairs generally heal cracks in welds and in base materials. In a preferred embodiment, however, a method is proposed that may include the application of braze material perhaps even prior to the occurrence of cracks.

Typically strain-age cracking may occur on the heat-up process for the stress relief cycle. In general terms, the braze filler material may be chosen based on the stress relieving temperature and the expected/anticipated crack width. During the stress relief hold cycle, the braze may melt and diffuse into any indications that have opened and may isothermally solidify, healing the cracks.

In certain preferred embodiments, the present invention may allow for a reduction of re-work and cycle time for the repair of superalloy buckets. In certain preferred embodiments, this process may also reduce fallout from the attempted welding re-work for difficult to repair indications or geometries. In certain preferred embodiments, this process further may incorporate the re-work into the original heat treatment schedule and may eliminate the need for further cleaning, component preparation, and heat treatment. And in certain preferred embodiments, the braze may fill in large strain-age cracks, as well as any micro-cracks or surface porosity, which may improve the quality of the repair.

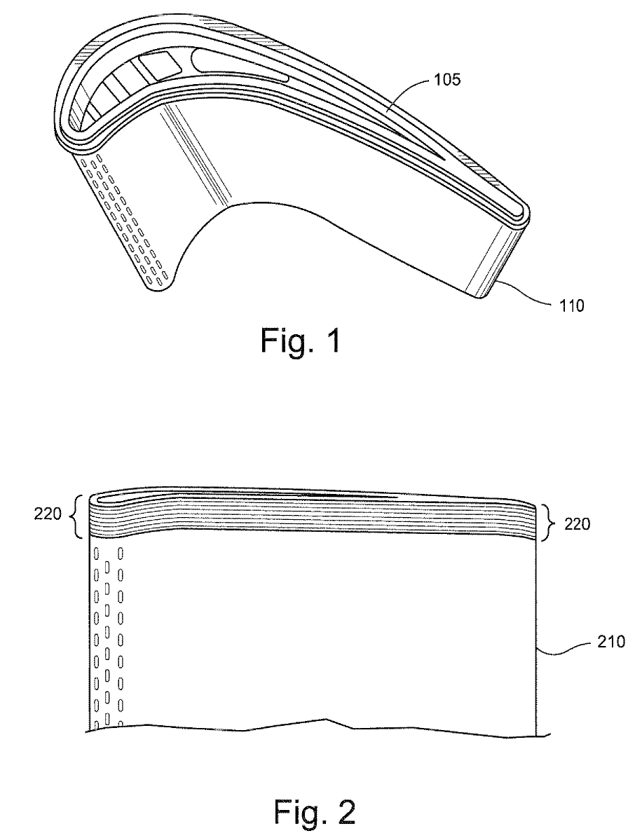

In a preferred embodiment, there is a method for repairing bucket or blade turbine components, with a combination repair of weld and braze. In a more preferred embodiment, the tip of a bucket is repaired in the following steps. Of course, metallic turbine components other than a tip of a bucket may also be subjected to this process. First, the tip of the bucket is weld repaired. Preferably, the welding is performed using a laser cladding process, although other well-known welding processes may be used. FIG. 1 illustrates a bucket 110 with tip 105, and FIG. 2 illustrates a bucket 210 with laser powder welded tip 220 after being weld repaired using a laser cladding process in accordance with an exemplary embodiment of the present invention.

Second, the weld is covered with a braze paste, Preferably, the braze paste may be composition (c) as described below, although compositions (a), (b) & (d) as well as other well-known braze materials may be used.

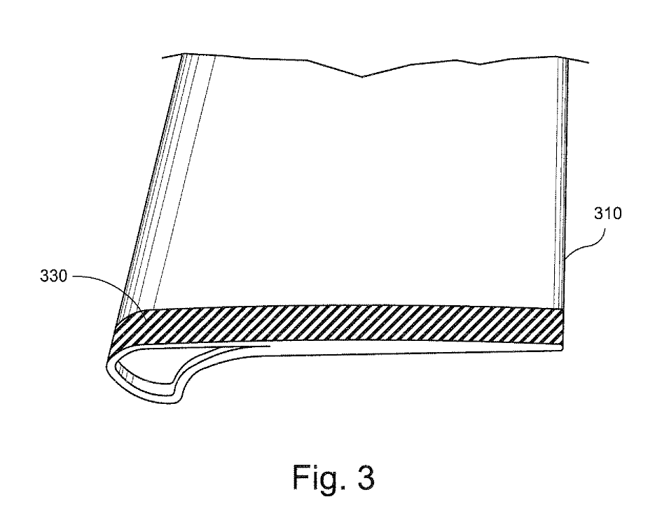

Third, the tip of the bucket is subjected to stress relief heat treatment. The post-weld stress relief heat treatment is preferably performed in a vacuum or an inert gas environment. FIG. 3 illustrates bucket 210 with tip 330 in the as-brazed condition.

Fourth, the tip may be optionally and preferably blended or machined to a final contour. After the fourth step is preformed, the tip may be inspected and ready for continued processing with little or no re-work.

Preferably, the braze material may be selected based on the desired stress relief heat treatment temperature, such that adequate flow and isothermal solidification may be achieved. Typically strain-age cracking may occur on the ramp-up to temperature, where the braze medium would flow into the newly formed indications and heal the cracks. Essentially the braze filler can be a single component mixture, where silicon (Si) is added as a melt point depressant. Four preferred nominal compositions containing exclusively silicon (Si) as a melt point depressant are: (a) Ni-19Cr-10Si (typically referred to by GE as B50TF81); (b) Ni-15Cr-8Si (typically referred to by GE as B50TF143); (c) Ni-17Cr-9.2Si-0.1B (typically referred to by GE as B50TF142); and (d) Ni-19Cr-9.5Si-9.5Mn (typically referred to by GE as B50TF99).

Because the repair can occur at the tip of a bucket, the oxidation resistance of the braze filler may be critical with respect to quality. Other melt point depressant such as boron (B) may not be as preferred, because the oxidation resistance of boron (B) containing braze filler metals may be inferior when compared to the weld filler metal being deposited. If oxidation resistance is not as relatively important, such as in the repair of low-fired turbine buckets (e.g., E-class buckets), braze filler metals containing B may be used.

In a preferred embodiment, the single component braze filler metals containing either boron (B) or silicon (Si) (or a combination of both) may be utilized if the anticipated post-weld strain-age cracks are between 0.001″ and 0.010″. If the post-weld strain-age cracks are expected to be between 0.010″ to 0.040″, superalloy powder may be added to the braze filler to facilitate a wide gap braze repair. Cracks up to 0.125″, furthermore, may be repaired with this method. It is possible that cracks even wider than 0.125 may also be repaired.

The method of a preferred embodiment including a combination weld and braze repair, may be conducted on a laser welded bucket tip repair, with an addition of braze paste to the surface of the part, prior to heat treatment.

In a preferred embodiment, this invention may be used as a repair method for restoring bucket tips and blade sections that require a weld restoration from cracking, erosion or oxidation. This may reduce re-work and cycle time for the repairs, as well as increase the range of materials that may be used for the repair. For example, this may allow for very brittle, high temperature oxidation resistant fillers to be utilized in repair applications. At the present time, these temperature oxidation resistant fillers may be difficult to weld.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. Furthermore, all disclosed and claimed numerical ranges and numerical measurements are approximate.

What is claimed is:

1. A method for welding and brazing a metallic component comprising the steps of:
welding the metallic component to create a welded component;
covering the welded component with a braze material to create a braze-covered welded component; and
subjecting the braze-covered welded component to stress relief treatment.

2. The method of claim 1, wherein the metallic component comprises a part of a turbine and comprises at least one superalloy chosen from: nickel-based, cobalt-based, iron-based, and nickel-iron-based superalloys.

3. The method of claim 1, wherein the metallic component is a bucket or blade.

4. The method of claim 2, wherein the step of welding is performed using a laser cladding process.

5. The method of claim 4, wherein the braze material is in a form selected from the group consisting of tape, powder, and paste.

6. The method of claim 5, wherein the braze material comprises boron as a melt point depressant.

7. The method of claim 5, wherein the braze material comprises silicon as a melt point depressant.

8. The method of claim 7, wherein the braze material is selected from the group consisting of: Ni-19Cr-10Si; Ni-15Cr-8Si; Ni-17Cr-9.2Si-0.1B; and Ni-19Cr-9.5Si-9.5Mn.

9. The method of claim 8, wherein the braze material further comprises superalloy powder.

10. The method of claim 4, wherein the step of subjecting the braze-covered welded component to stress relief treatment is performed in a vacuum or inert gas environment.

11. The method of claim 10 further comprising machining the braze-covered welded component into a final shape.

12. The method of claim 11, wherein the brazed-covered welded component is created prior to the presence of cracks in the component caused by heat treatment.
